(19) United States
(12) Patent Application Publication
(10) Pub. No.: US 2019/0033439 A1
(43) Pub. Date: Jan. 31, 2019

(54) Artificial intelligence enabled adaptive digital beam

(71) Applicants: RICHARD GU, PLANO, TX (US); TIEJUN SHAN, PLANO, TX (US)

(72) Inventors: RICHARD GU, PLANO, TX (US); TIEJUN SHAN, PLANO, TX (US)

(21) Appl. No.: 15/661,339

(22) Filed: Jul. 27, 2017

(51) Int. Cl. G01S 13/00; G01S 13/08; G01S 13/93

(52) U.S. Cl. CPC G01S 13/00; G01S 2013/0245; G01S 13/931; G01S 13/08

(57) ABSTRACT

The present invention includes an artificial intelligence system for acquiring real-time positioning and geographic data and generates a control signal received by a digital beam forming and steering system for adaptive detection, ranging, and tracking of moving objects for example vehicles. This system is particularly effective in detecting and tracking moving vehicles, obstacles and pedestrians on curved roads and blind spots behind corners of roads.

### FIELD OF THE INVENTION

The present invention is related to an adaptive digital beam forming and steering system which may be mounted in a mobile or stationary body such as a vehicle such as a automobile, truck, motorcycle, bicycle or other such device to detect the direction of a target object such as an obstacle or other vehicle and its distance and velocity relative to the mobile body.

### BACKGROUND OF THE INVENTION

Compared with straight road, more accidents happened at intersections when cars try to turn around the corner, however, are unable to detect and avoid incoming cars or pedestrians concealed behind the corner. Traditional advanced driver-assistance systems (ADAS) are capable of adaptively tracking and following cars on straight road, but lack the capability of tracking and following cars effectively on curved road or at the corner of the intersections. One of the problems may be that an obstruction such as a building, hill or other such obstruction may be blocking the clear line of sight.

### CITATION LIST

### Patent Citations

[1] R. B. Dybdal et al., “System and method for antenna tracking,” U.S. Pat. No. 7,800,537

### Non Patent Citations

[1] J. R. Guerci, “Cognitive radar: A knowledge-aided fully adaptive approach,” 2010 IEEE Radar Conference, Washington, DC, 2010, pp. 1365-1370.

### A. Sume et al., “Radar Detection of Moving Targets Behind Corners,” in IEEE Transactions on Geoscience and Remote Sensing, vol. 49, no. 6, pp. 2259-2267, Jun. 2011

### SUMMARY OF THE INVENTION

The present invention includes a phased-array based detection and ranging system mounted on the vehicle that has online artificial intelligence engine that may adaptively control the digital beam forming and steering system to track objects such as other vehicles and obstacles independent of any road condition, thus provide a solution to the afore stated problems and significantly improve the robustness of the tracking of the moving or stationary objects.

### BRIEF DESCRIPTION OF THE DRAWINGS

FIG. 1 shows the detection and ranging system of the present invention;

FIG. 2 shows the AI system collecting information of the present invention;

FIG. 3a shows the block diagram of AI based multiple antenna beam forming system;

FIG. 3b shows the TX block in FIG. 3a;

FIG. 4 illustrate the winding road with all of the three non-line-of-sight of objects;

FIG. 5 shows the relay device of the present invention;

FIG. 6 illustrates a Radar receiver of the present invention;

FIG. 7 shows matching and finding maximum likelihood estimation of the received signal V and the lookup table U;

FIG. 8 illustrates an equation of the present invention.

### DETAILED DESCRIPTION OF THE INVENTION

The present invention includes a tracking system which may include combining an artificial intelligence engine with a phased-array detection and ranging system. The phased-array detection and ranging system may form a directional scanning beam (with narrow angle) to detect objects or obstacles in front of the vehicle. The artificial intelligence engine may acquire and combine several different kinds of information, including a digital map which may be pre-acquired and which may be a roadway map, a camera imaging data of the road way ahead of the vehicle, a real-time GPS signal or other positioning signals to provide the location of the vehicle, and geographic information to determine hills and valleys along the roadway, etc. The artificial intelligence engine (AI), then may perform real-time online computing of the condition of the road by combining the above data, such as direction, curvature, and slope and blind spot. Based on the computing results, the artificial intelligence engine generates a control signal in accordance with the computing results to the digital beam forming system, which may include a multitude of active antennas, the power level may be input for each antenna, and the phase shift information may be input for each antenna. The digital beam forming system then generates a beam based upon the power level and phase shift information with certain detecting range and the steering angle. For detecting objects in blind spots behind the corner, The beam formed from the artificial intelligence engine could be a light wavelength, a millimeter wave length, a ultrasound wavelength, or an electromagnetic wavelength generated waves at other wavelength ranges.

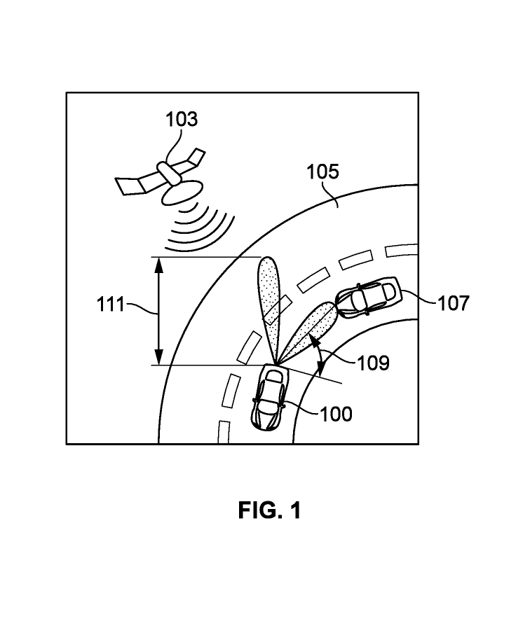

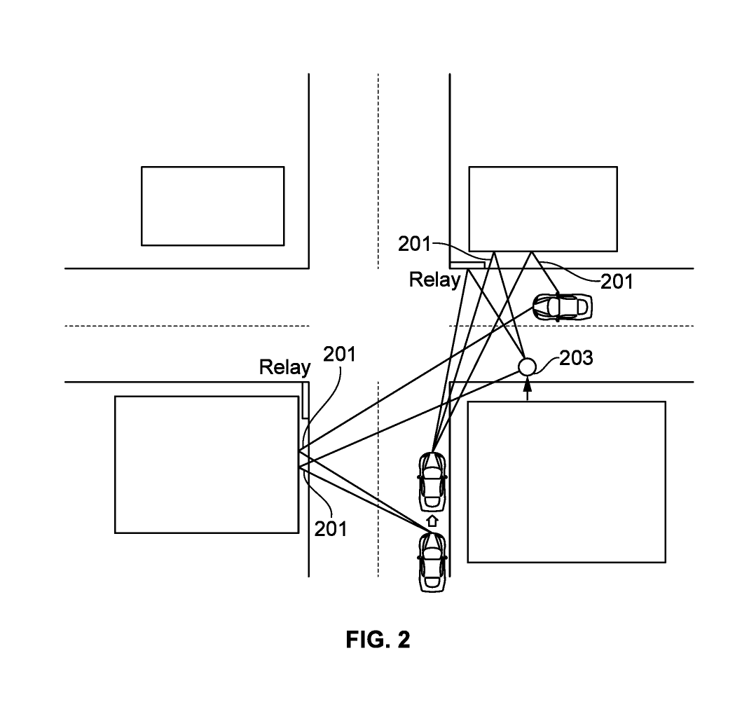

Input data for the digital beam forming system:
Real-time geographic location coordinates for the vehicle acquired from Global Positioning System or other types of systems.
Real time video data for the vehicle obtained from on vehicle camera search of the surrounding environment to the vehicle.
Pre-acquired digital map of the region or state where the vehicle will be operating, which may be pre-saved to storage media or downloaded when WiFi signal is available.
Geographic information showing surface topology and infrastructures of the area in front of the vehicle
Road image which may be provided by Google or another environment image provider showing the surrounding environment to the vehicle.
Forming a Geographic Radar electromagnetic wave profile database with road test data on curved road and blind spots on the corners: road test data for electromagnetic wave shown in FIG. 1 and FIG. 2. over different weather conditions and different road conditions. Driving a vehicle with transmitting beam forming Radar in the curved road or approaching corners. Collecting reflection multipath electromagnetic waves with known conditions. Processing the EM data to predict the conditions of the roadway based upon the stored road test data, extracting useful information, and storing them in database.

With above input data, the artificial intelligent system (1) could estimate the road condition, such as the direction that the vehicle will take, curvature of the road, slope of the road, (2) and good quality reflection spots behind the corner, therefore, the best beam forming angle and power may be estimated.

Scenario #1: “Tracking on curved open road”

For open road, the beam could directly identify the targets (vehicles and none moving objects with no interference with other objects. Under this scenario, the present invention developes a cognitive radar system with adaptive beam steering capability that could rapidly identify moving vehicles and pedestrians. Guided by the artificial intelligence system with geographic data input, the cognitive radar system of the present invention could minimize the time and computational power of the search-and-track process on a curved open road.

Scenario #2: “Seeing around the corner”

For roads/streets with structures on the side of the path of the vehicle, such as buildings, trees, and mountains, the vehicles in front of the vehicle could be concealed by the structures or terrain with no direct view between the two vehicles. To detect objects behind the corner, the present invention uses a machine learning algorithm to effectively classify pedestrians and vehicles by micro-Doppler signatures analysis. The Micro-Doppler signature for a human target then a micro-Doppler signature for a vehicle, because the human target is simultaneously walking and breathing, being different from a moving vehicle.

Scenario #3: “Seeing around the corner” may use a digital map or a camera or road image such as provided by Google to determine the presence or absence of a surrounding building or object that blocks the direct view when a vehicle approach cross-road or corner, AI of the present invention analyzes the surrounding image of the crossroad or corner and finds some good quality RADAR reflection spots. The RADAR of the vehicle uses the information to control the beam forming and direction device through reflection at the radar reflection spot to detect any blind-spot pedestrian, obstacles, or cars that other sensors are not able to see.

FIG. 1 shows how the detection and ranging system mounted on a vehicle 100 using the GPS signal 103 and the digital map to control the beam steering to track vehicles 105, 107 moving in the same or opposite directions over a curved road in the line-of-sight condition. AI knows the curvature of the road and comparing the different position/time of EM (electro-magnetic) reflection waves, calculates the beam angle 109 and distance 111 to track the objects 105, 107 on the curved road.

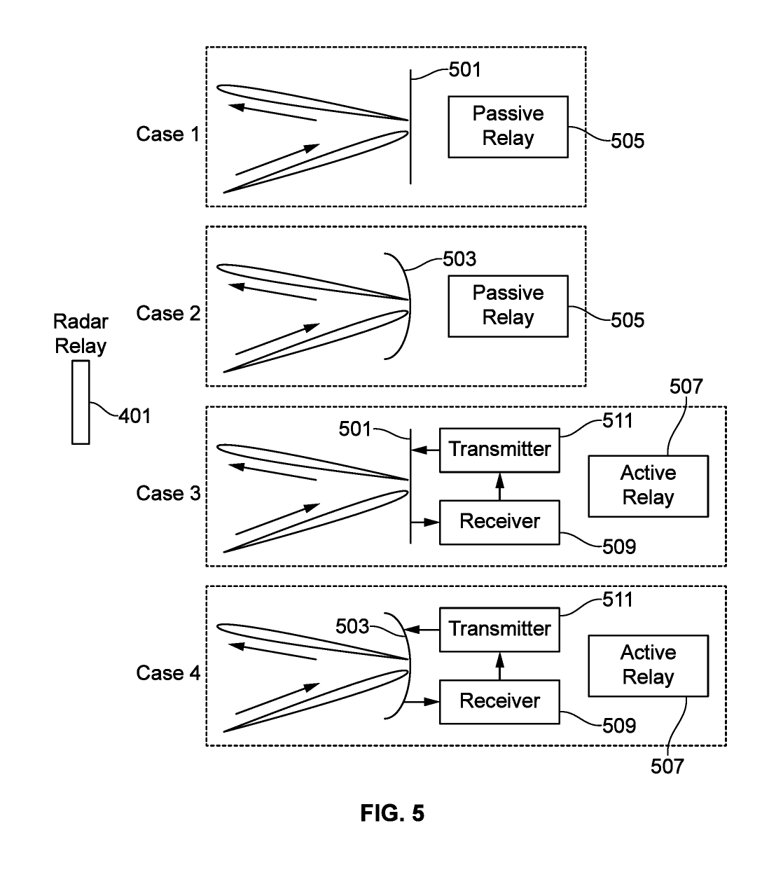

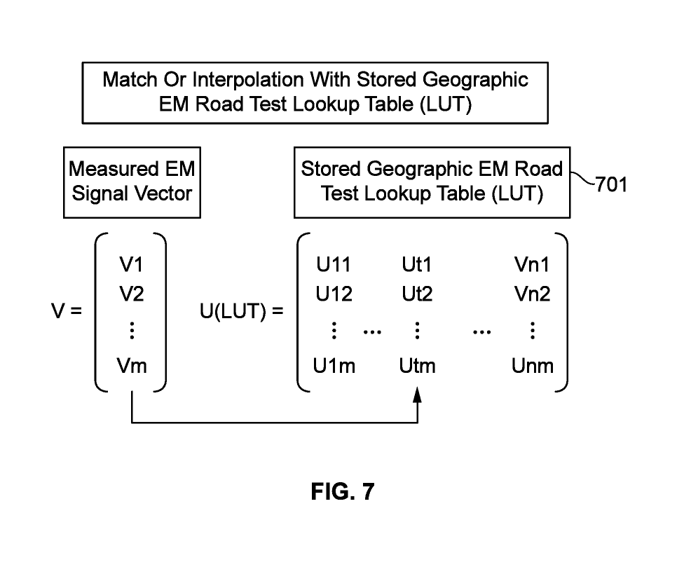

FIG. 2 shows concept of AI system collecting information of surrounding environment of the corner and finding the good quality reflection spots 201 to detect vehicles, obstacles and pedestrians behind the blind spots in non-line-of-sight condition. A good quality spot 201 is found by images of the area. For example, if there is a sufficiently tall building with a surface having a angle that is within criterion then this may qualify as a good quality spot for reflection. On the other hand, if there are nothing but trees in the image of the area, then a good quality spot may not be available.
a. If good quality spots 201 are found, next, the present invention builds a Geographic Radar electromagnetic wave profile database 701 (see FIG. 7) using road test data to generate an EM reflection lookup table U(LUT) 701 (FIG. 7). The U(LUT) 701 is generated by moving the vehicle at different positions approaching a hypothetical cross-roading, and having different blind objects at different positions in measuring the EM wave reflected from these different blind objects.
b. If no good reflection spots are found, Relay devices 203 (FIG. 5) may be placed at different corners as needed to generated good quality reflection spots. Repeat the above steps to generate a lookup table for multiple relay devices.

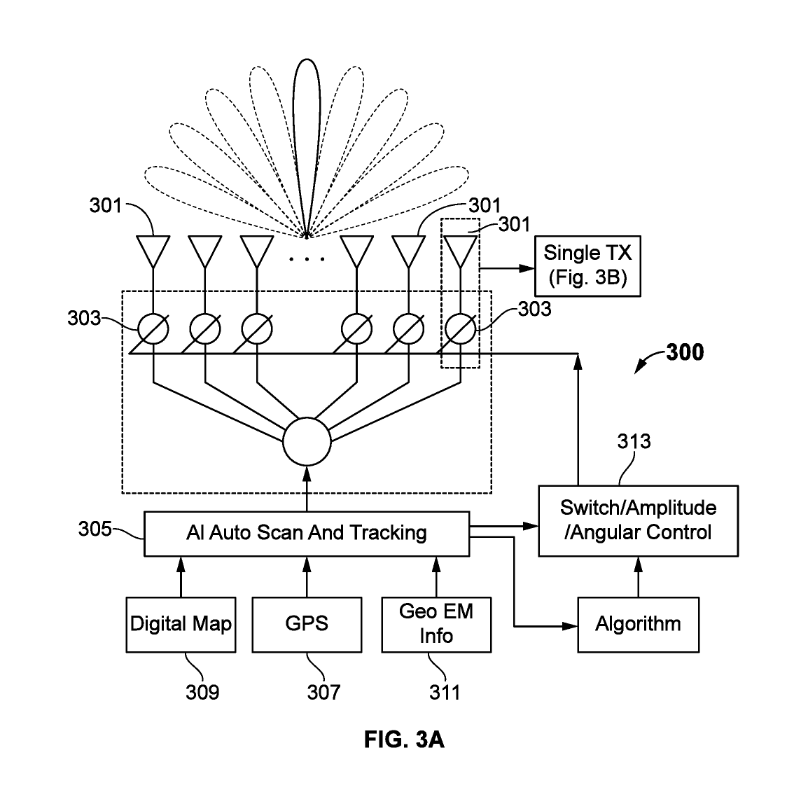

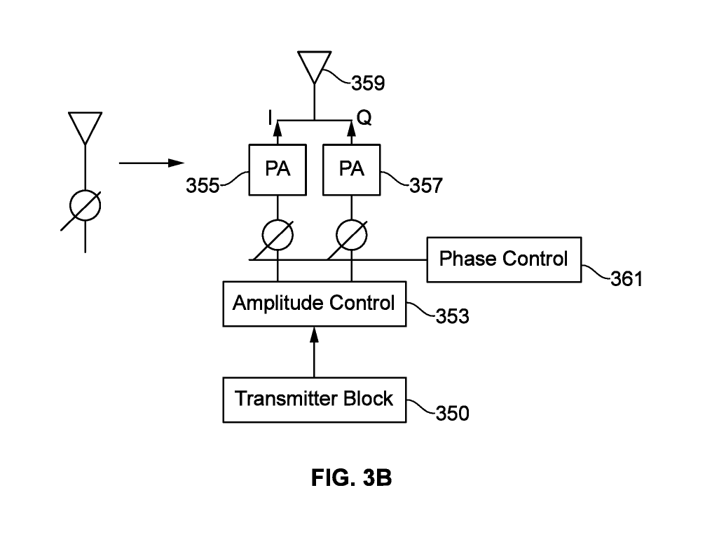

FIG. 3a shows the block diagram of AI based multiple antenna beam forming system 300. Beam can scan from approximately −80 degrees to 80 degrees or may be with a narrower range. Each antenna 301 may be controlled by a transmitter 303 (TX, shown in FIG. 3b). The antenna array may be controlled by artificial intelligence with auto scan and tracking function 305, which obtains input information from at least one of the GPS 307, the digital map 309, and the measured geographic electro-magnetic wave information 311. AI of the present invention, generates targeted beams by selecting and switching multiple group of TX with desired amplitude and angular control 313.

FIG. 3b is TX block in FIG. 3a. The transmitter TX may include I 355 and Q 357 channels to drive an antenna 359. Each channel may include an independent phase 361 and amplitude control 353 and a transmitter block.

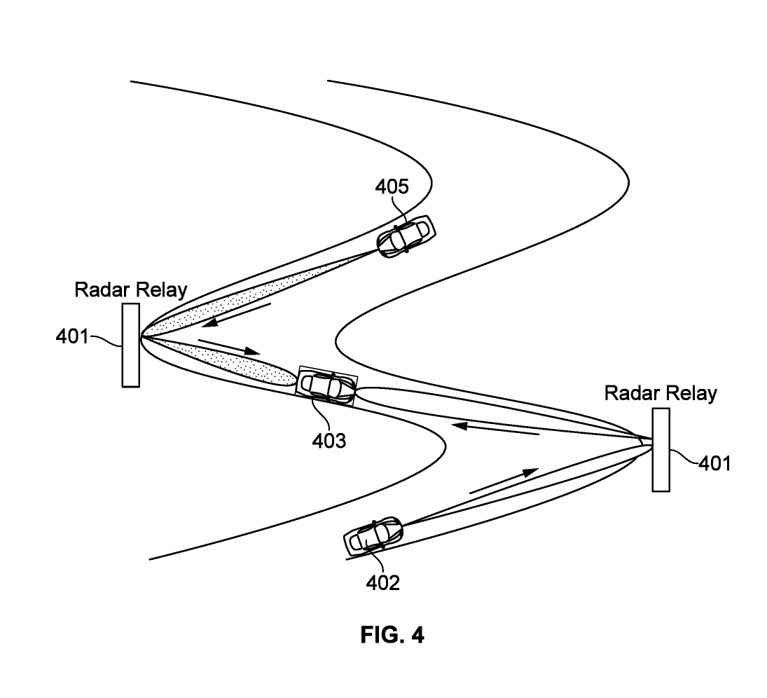

FIG. 4 illustrate winding road with all the 3 non-line-of-sight of cars. With an added relay device 401, (which detailed describe in FIG. 5), and the data from the digital map and the GPS, the first car 402 detects EM wave from the second car 403 moving in the opposite direction through relay device; the third car 405 detects EM wave from the second car 403 moving in the same direction through the relay device.

FIG. 5 shows that the relay device 401 may be flat 501 or an ellipse 503 reflection surface or other shapes. The relay may be passive 505 or active 507 with a receiver 509/transmitter 511, which detect the signal, and amplify the signal and re-transmit it back to the vehicle.

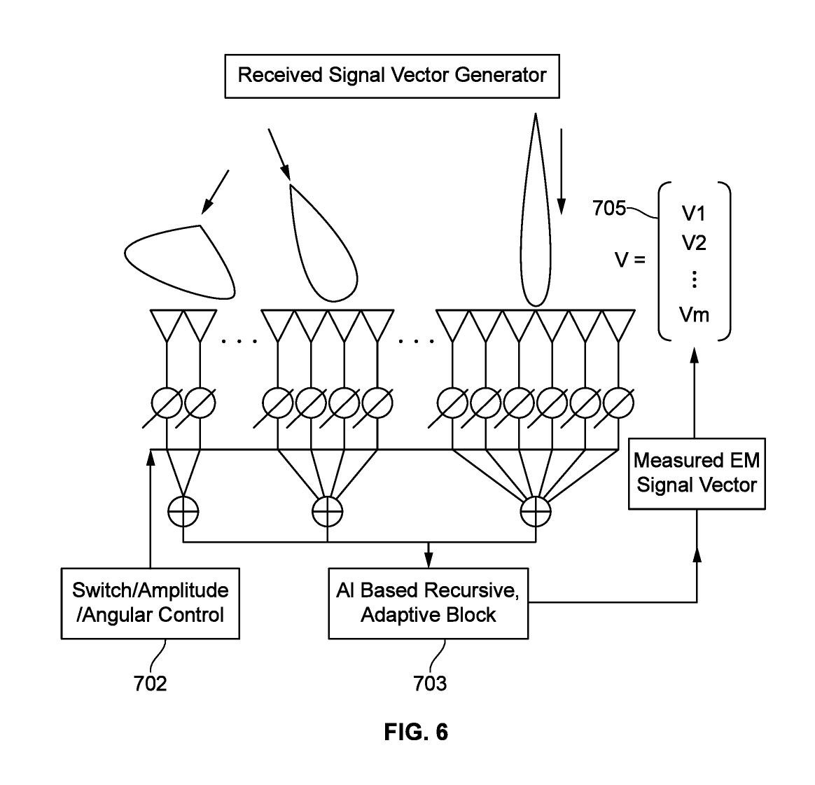

FIG. 6 illustrates a Radar receiver, the receiver may be with or without beam forming and amplitude and angular control 702. With the same subgroup setup of the transmitter, the AI based processor 703 performs recursive and adaptive least-mean-square calculation to get an EM receiver value. If the number of receivers is M, the receiver measures up to M receiver vector V(V1,V2, . . . , Vm) 705 at a fixed position.

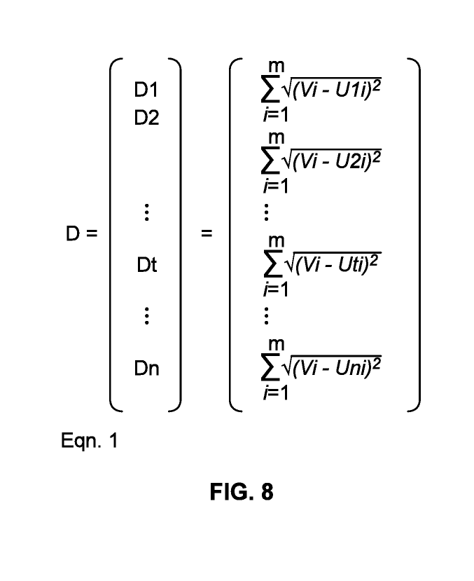

FIG. 7 shows matching and Finding maximum likelihood estimation of the received signal V and the lookup table U. Eqn. 1 as shown in FIG. 8 shows how the Euclid distance vector D between vector V and array U is calculated. After finding the mimimum Dt=min(D1,D2, . . . Dt, . . . Dn), which may be the maximum likelihood estimation of the environment which represents the objects in the blind spots.

1. An adaptive detection and ranging system, comprising:
an artificial intelligence system for acquiring real-time positioning and geographic data and for generating a control signal;
a digital beam forming and steering system for receiving the control signal and for adaptive detection, ranging, and tracking of moving objects.

2. An adaptive detection and ranging system as in claim 1, wherein the adaptive detection and ranging system tracks objects on a curved open road

3. An adaptive detection and ranging system as in claim 1, wherein the adaptive detection and ranging system detects and track objects around a corner of the road

4. An adaptive detection and ranging system as in claim 1, wherein the artificial intelligent system receives GPS data of the GPS, the digital map, and the measured geographic electro-magnetic wave information

5. An adaptive detection and ranging system as in claim 1, wherein the artificial intelligent system receives digital map data.

6. An adaptive detection and ranging system as in claim 1, wherein the artificial intelligence system receives electromagnetic wave data.

7. An adaptive detection and ranging system as in claim 1, wherein the artificial intelligence system determines a reflective position
